(19) United States
(12) Patent Application Publication
(10) Pub. No.: US 2013/0327828 A1
(43) Pub. Date: Dec. 12, 2013

(54) IMAGE CAPTURE SYSTEM

(71) Applicants: Ron LAWSON, Harrisburg, PA (US); John C. COULSON, Harrisburg, PA (US)

(72) Inventors: Ron LAWSON, Harrisburg, PA (US); John C. COULSON, Harrisburg, PA (US)

(73) Assignee: SEIDENADER MASCHINENBAU GMBH, Markt Schwaben (DE)

(21) Appl. No.: 13/489,661

(22) Filed: Jun. 6, 2012

(51) Int. Cl. G06K 7/14

(52) U.S. Cl. 235/440; 235/470; 235/454

(57) ABSTRACT

An image capture system includes an imaging device and a reflective arrangement having reflective components positioned relative to an article to reflect portions of a surface of an article to the imaging device. The reflective arrangement reflects an image of the portions of the surface of the article for capture by the imaging device, the image collectively representing a contiguous periphery of a predetermined region of the surface of the article, the image usable to identify a symbol code on the predetermined region.

### FIELD OF THE INVENTION

The present invention relates to image capture systems, and more specifically, the present invention relates to image capture systems that are configured to identify a symbol code on an article.

### BACKGROUND OF THE INVENTION

In many industries, for reasons including business efficiency and public safety, it has become extremely important to collect data associated with articles during the manufacturing process using image capture devices. For example, the image capture devices may be utilized to read and interpret bar codes associated with individual manufactured articles. More specifically, the bar codes are two-dimensional bar codes, sometimes referred to as matrix codes, which are capable of storing significantly more information than previously available with one-dimensional bar codes.

Conventional utilization of image capture devices involve direct line of sight arrangements that are positioned coplanar with the article matrix codes in order to capture images associated with the matrix codes. Such arrangements may involve multiple image capture devices positioned at 90 degrees with respect to each other in order to view a continuous peripheral surface of the article, permitting capture of an image of the article matrix code by the image capture device, irrespective the orientation of the article. Such an arrangement is shown in FIG. 1. However, this arrangement requires a large amount of area, sometimes referred to as a “footprint”, which would not be desirable in a production area, and would also be difficult to integrate into existing article production lines.

Moreover, imaging software is often utilized to process the captured image, involving “stitching” in which adjacent captured images are overlain to produce a contiguous surface of the manufactured article in an effort to identify the matrix code associated with the article. While sophisticated, such software typically involves base assumptions, such as relating to the geometry of the article. For example, for a cylindrically shaped article, software may assume the article possesses a perfectly uniform curvature. However in reality, the article may contain non-uniform features, such as indentations or an otherwise out-of-round condition. Therefore, when the software is utilized, such features introduce distortions in the captured image and when the edges of such images are used as bases to combine or “stitch” adjacent images into a larger image, yet further distortion is introduced in the captured image, resulting in a further reduction in quality of the image. Additionally, such sophisticated software requires additional time in order to process the image that may adversely affect the speed of the article production line, which is especially undesirable in high-volume manufacturing operations.

An image capture system operable within a compact footprint while permitting capture of an image of the article matrix code irrespective the orientation of the article, and without disadvantages such as associated with “stitching” of adjacent image portions or other previously discussed disadvantages would be desirable in the art.

### BRIEF DESCRIPTION OF THE INVENTION

According to an embodiment, an image capture system includes an imaging device and a reflective arrangement having reflective components positioned relative to an article to reflect portions of a surface of an article to the imaging device. The reflective arrangement reflects an image of the portions of the surface of the article for capture by the imaging device, the image collectively representing a contiguous periphery of a predetermined region of the surface of the article, the image usable to identify a symbol code on the predetermined region.

According to another embodiment, an image capture system includes at least two imaging devices and a reflective arrangement having reflective components positioned relative to an article to reflect portions of a surface of an article to each imaging device. The reflective arrangement reflects an image of the portions of the surface of the article for capture by each imaging device, the image collectively representing a contiguous periphery of a predetermined region of the surface of the article, the image usable to identify a symbol code on the predetermined region.

According to another embodiment, a method for capturing an image includes providing an imaging device and positioning reflective components relative to an article to reflect portions of a surface of an article to the imaging device, the reflective components reflecting an image of the portions of the surface of the article for capture by the imaging device, the image collectively representing a contiguous periphery of a predetermined region of the surface of the article, the image usable to identify a symbol code on the predetermined region. The method further includes actuating the imaging device.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a prior art image capture system.

FIG. 2 illustrates schematically an exemplary identification of the present disclosure.

FIG. 3 illustrates an upper perspective view of an exemplary image capture system of the present disclosure.

FIG. 4 illustrates a plan view of an exemplary image capture system of the present disclosure.

FIG. 4A illustrates schematically an exemplary image capture system of the present disclosure.

FIGS. 4B and 4C illustrate schematically respective exemplary captured images of the present disclosure.

FIG. 5 illustrates a view taken along line 5-5 of FIG. 4 of the present disclosure.

FIG. 6 illustrates a view taken along line 6-6 of FIG. 4 of the present disclosure.

FIGS. 7A-7C illustrate incremental steps of operations of an exemplary image capture system of the present disclosure.

Wherever possible, the same reference numbers will be used throughout the drawings to represent the same parts.

### DETAILED DESCRIPTION OF THE INVENTION

Provided is an image capture system utilizing manipulation of an optical path of an image, such as by reflection and/or splitting with respect to an imaging device in order to significantly reduce the size or footprint of the system. Additionally, the system permits capture of an image of an article matrix code by the image capture device, irrespective the orientation of the article in a manner conducive with high-volume manufacturing operations.

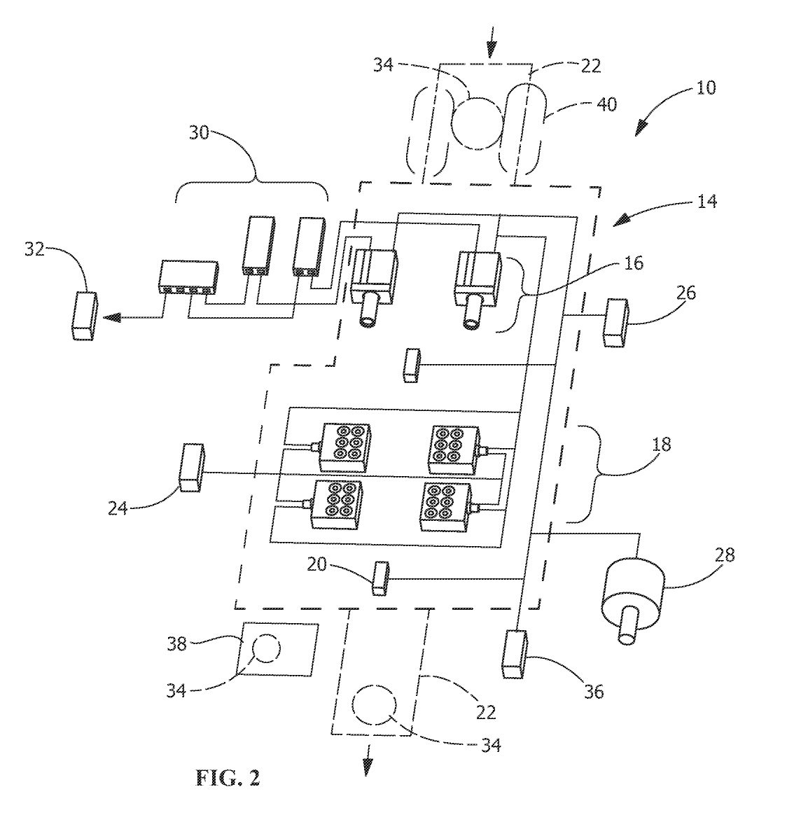

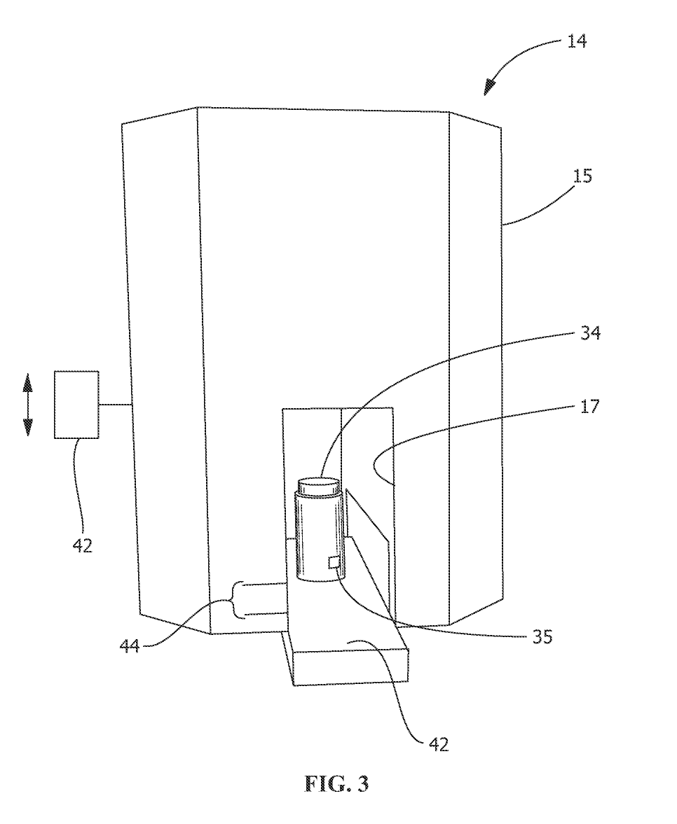

FIG. 2 illustrates an identification system 10 usable with an image capture system 14, such as for purposes of maintaining traceability of articles throughout the manufacturing process, such as by capturing images of symbol code 35 (FIG. 3) associated with each article 34 (FIG. 3). For example, image capture system 14 includes one or more imaging devices 16 usable to capture one or more images of an article 34 conveyed through image capture system 14, such as by conveyor 22. Articles 34 conveyed through image capture system 14 may use sensors 20 to detect the presence of the articles, optionally utilizing an article spacing device 40 prior to the articles entering image capture system 14. A power supply 24 provides electrical power to illumination devices 18 that are operably associated with one or more imaging devices 16 in order to provide a higher quality image for use by image capture system 14. Identification system further includes a controller 26 for controlling the operation of various components/operations, including an encoder 28 and power/data delivery system 30, such as Power over Ethernet (PoE), which may be usable to deliver captured images to data collection software 32 or transmitting software code that has been read. In the event an image of symbol code 35 of article 34 is not captured or decoded for any reason, a reject device 36, such as a pneumatically actuated device, a pressurized air source or other type of device moves the article from conveyor 22 and into a container 38 to permit subsequent review of the article.

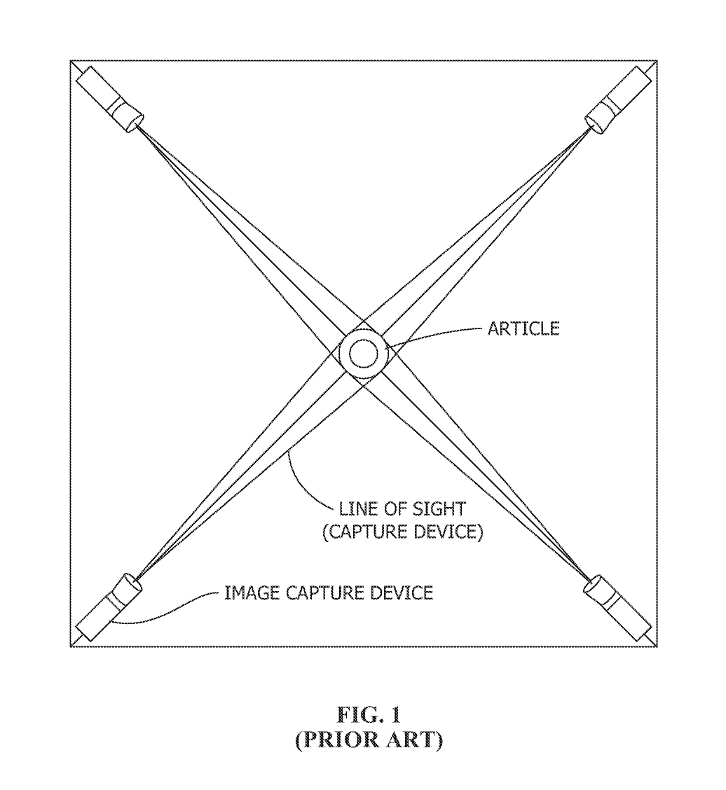

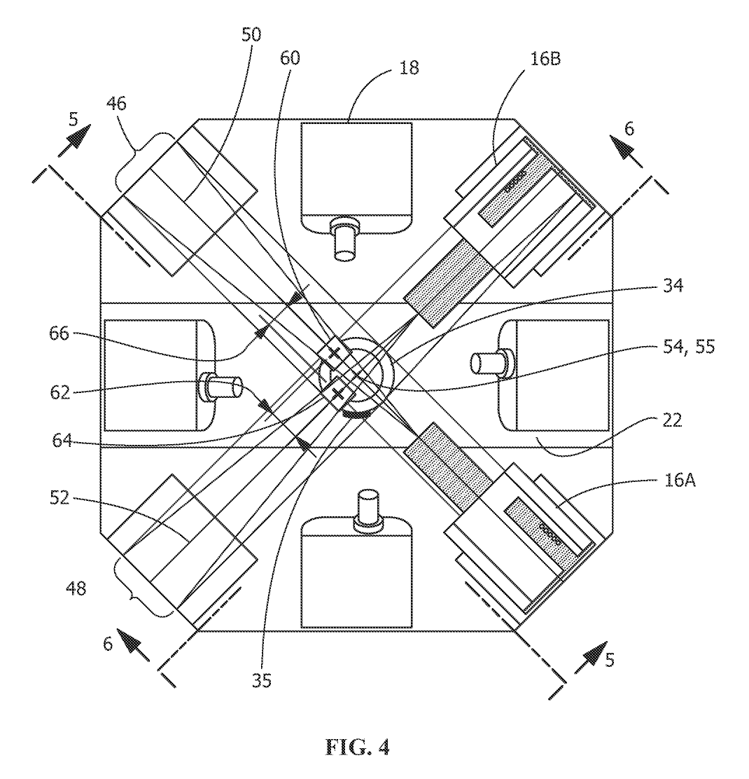

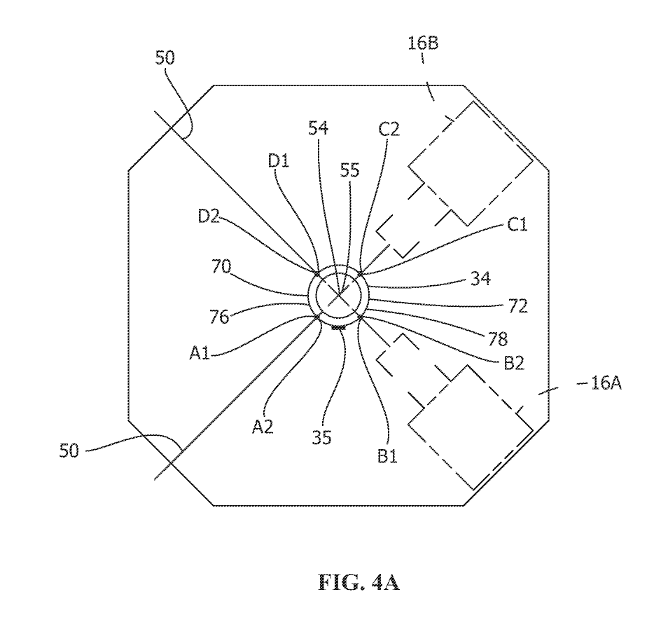

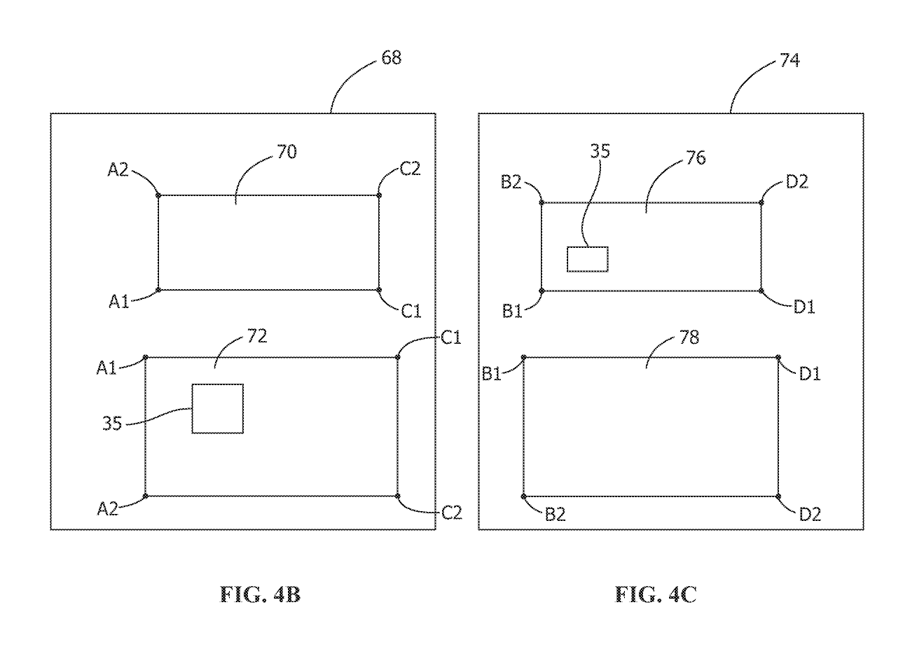

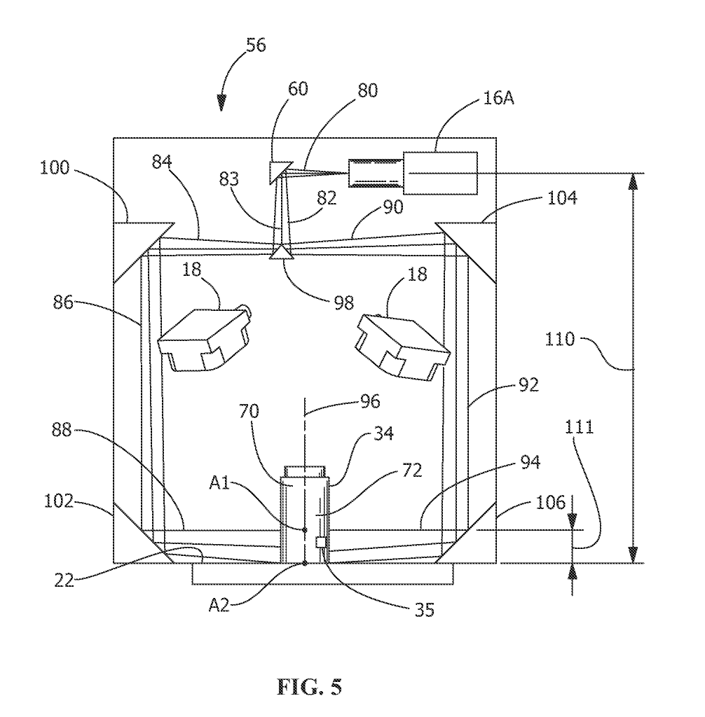

As shown in FIGS. 3-4, image capture system 14 includes a structure 15, such as a substantially enclosed structure having an opening 17 for receiving articles 34 having respective symbol code 35, such as from conveyor 22. However, in one embodiment, structure 15 may include a substantially open framework that supports components of image capture system 14. As further shown in FIG. 3, structure 15 includes an adjustment device 42, such as a manually operated mechanical actuating mechanism or a powered adjustment device, such as an electric, pneumatic, hydraulic or other type of propulsion source in combination with a control device such as a joystick, lever, button or other interface that permits adjustment of structure 15 in a vertical direction with respect to conveyor 22. That is, once components contained inside of structure 15 relating to image capture system 14 have been installed and calibrated for operation, including, but not limited to imaging device(s) 16 illumination device(s) 18 sensor(s) 20 (FIG. 1), these components are generally intended to remain in their installed position inside of structure 15. As will be disclosed in further detail below, optical path(s) 46 (FIGS. 4, 5) associated with the operation of imaging device(s) 16 are configured to capture an image of a portion of the surface of article 34, the image usable to identify symbol code 35 associated with the article. The portion of the surface of article 34 containing symbol code 35 is positioned within a predetermined region, such as a band. Accordingly, structure 15 includes indicia 44, such as a pair of parallel lines formed in structure 15 and corresponding with the predetermined region. Stated another way, indicia 44 corresponds to a vertical range of an optical path that would encompass symbol code 35 of article 34. In other words, irrespective the rotational orientation of article 34 (i.e., the direction the symbol code 35 faces within structure 15), so long as symbol code 35 is located within the vertical range of the optical path as indicated by indicia 44, the optical path permits image capture of symbol code 35 of article 34.

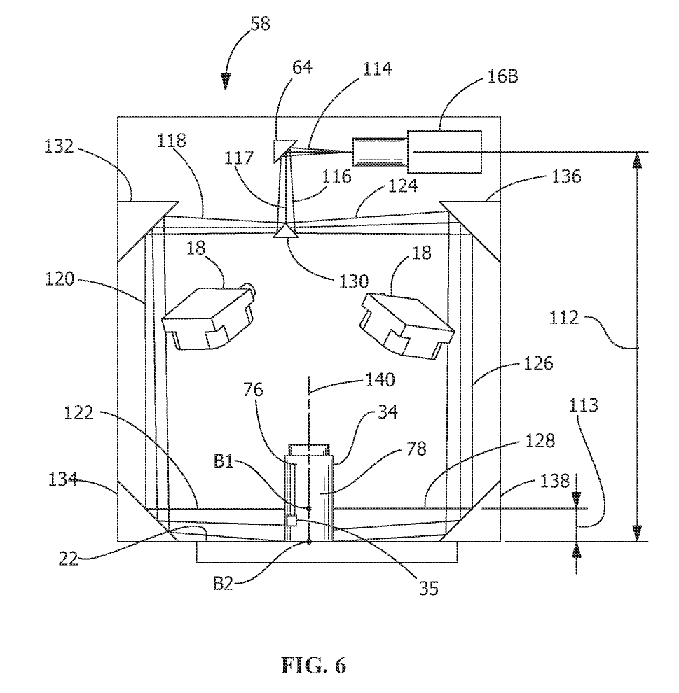

As shown in FIGS. 4 and 4A, which are plan views of image capture system 14, imaging devices 16A, 16B have respective optical paths 46, 48 for capturing an image of article 34 that includes symbol code 35 associated with the article traveling along conveyor 22. In one embodiment, image capture system 14 may move relative to article 34 for capturing an image of article 34 that includes a symbol code 35. In one embodiment, image capture system 14 may include a single imaging device, such as imaging device 16A. In another embodiment, as shown in FIG. 4, image capture system 14 may include a pair of imaging devices, such as imaging devices 16A, 16B. In further embodiments, image capture system 14 may include more than two imaging devices, if desired. As further shown in FIGS. 4, 4A, 5 and 6, reflective components 60, 64 of respective imaging devices 16A, 16B are both oriented 90 degrees from each other and also horizontally spaced or offset relative to a line, such as centerline 55 extending through center position 54 that is defined by the intersection of image planes 96, 140. As shown collectively in FIGS. 4-5, reflective component 98 is positioned relative to reflective component 60 such that optical path portion centerline 83 is parallel to centerline 55. Also, as shown collectively in FIGS. 4 and 6, reflective component 130 is positioned relative to reflective component 64 such that optical path portion centerline 117 is parallel to centerline 55. Thus, reflective components 60, 98 of optical path 46 and 64, 130 of optical path 48 are offset from each other.

For example, as shown in FIG. 4, reflective component 60 associated with imaging device 16A has a substantially horizontal offset 62 relative to centerline 55 of image capture system 14. Similarly, reflective component 64 associated with imaging device 16B has a substantially horizontal offset 66 relative to centerline 55 of image capture system 14. In addition, as shown in FIG. 5, optical path portion 80 associated with imaging device 16A is positioned at a distance 110 vertically above the surface of conveyor 22. As shown in FIG. 6, optical path portion 114 associated with imaging device 16B is positioned at a distance 112 vertically above the surface of conveyor 22, which distance 110 may be equal to or different from distance 112. If distance 110 is different from distance 112, the two distances would be vertically offset from each other. In this exemplary embodiment, horizontal offsets and angular offsets relative to centerline 55 prevent optical path 46 associated with imaging device 16A and optical path 48 associated with imaging device 16B from interfering with each other. This interference is avoided by preventing the reflective surface of corresponding reflective components 60 and 98 (FIG. 5) of optical path 46 (FIG. 4) from being located in the same position or being coincident with the reflective surface of corresponding optical components 98 and 130 (FIG. 6) of optical path 48 (FIG. 4). In other embodiments, optical paths of respective imaging devices can be arranged such that interference between the optical paths can be prevented by employing an offset in a single direction.

It is to be understood that the term offset, such as between corresponding reflective components of optical paths 46, 48, can include at least one of a spacing in at least one direction and/or a spacing as a result of an angular rotation about one or more axes, such that the reflective surfaces of the corresponding reflective components are not coincident.

It is to be understood that the terms horizontal and vertical in the context of horizontal offsets and vertical offsets are not intended to be limiting, but merely used to aid in the understanding of the invention, as clearly offsets in other directions, including non-orthogonal directions may be utilized.

It is to be understood that in an exemplary embodiment disclosed herein, optical path centerlines, such as optical path centerlines 50 and 52 (FIGS. 4 and 4A) and image planes 96 and 140 (FIGS. 5 and 6, respectively) are coincident with center position 54. However, in other embodiments, which may have one or more imaging device(s) and corresponding optical path(s), the optical path centerline(s) and image plane(s) may not be coincident with center position 54. However, as will be described in further detail below, it may be desirable that the optical path centerline(s) and image plane(s) be positioned in close proximity relative to center position 54.

As shown collectively in FIGS. 4, 4A, 4B and 5, optical path 46 for imaging device 16A includes a reflective arrangement 56 having reflective components 60, 98, 100, 102, 104, and 106. Optical path 46 of imaging device 16A includes optical path portion 80 extending between imaging device 16A and reflective component 60, optical path portion 82 extending between reflective component 60 and reflective component 98, optical path portion 84 extending between reflective component 98 and reflective component 100, optical path portion 86 extending between reflective component 100 and reflective component 102, and optical path portion 88 extending between reflective path 102 and surface portion 70 of article 34. Surface portion 70, which represents a portion of the image to be captured by imaging device 16A, involves optical path portions 80, 82, 84, 86, and 88 and includes a predetermined portion of the surface of article 34, such as a portion of a band of the surface of article 34 as defined by points A1, A2, C1, and C2 which correspond to an intersection of image plane 96 and article 34 that is coincident with center position 54. Similarly, surface portion 72 is opposite of surface portion 70 and also represents a portion of the image to be captured by imaging device 16A, involves optical path portions 80, 82, 90, 92 and 94 extending respectively, between imaging device 16A and reflective component 60, between reflective component 60 and reflective component 98, between reflective component 98 and reflective component 104, between reflective component 104 and reflective component 106, and between reflective component 106 and surface portion 72 of article 34. Surface portion 72, which represents a portion of the image to be captured by imaging device 16A involves optical path portions 80, 82, 90, 92, and 94 and includes a predetermined portion of the surface of article 34, such as a band of the surface of article 34 as defined by points A1, A2, C1, and C2 which correspond to an intersection of image plane 96 and article 34 that is coincident with center position 54.

As shown in FIGS. 4A, 4B and 5, surface portion 70 and surface portion 72 each represent an image to be captured by imaging device 16. Since each of opposed surface portions 70, 72 defines the same points (A1, A2, C1, and C2) and the same image plane (96), surface portions 70, 72 represent a contiguous periphery of a predetermined region, such as a band of article 34. A width of the band of article 34 corresponds to a spacing, distance or predetermined region 110, which should correspond to the spacing between indicia 44 associated with structure 15 (FIG. 3). As further shown in FIG. 4B, surface portions 70, 72 are combined in a single collective image 68, in which symbol code 35 is shown as part of the captured image associated with surface portion 72. By virtue of offset 62 (FIG. 4) of reflective components 60, 98 relative to center position 54 (FIG. 4A), in which reflective component 98 is a splitter, i.e., an optical reflective component for dividing or splitting optical path portion 82 into separate optical path portions 84, 90, the area of captured image of surface portion 70 is slightly smaller than the area of captured image of surface 72 as shown in collective image 68 in FIG. 4B (assuming the same reflective components are used for otherwise symmetric optical path portions 84, 90 and their respective subsequent path portions). Additionally, by virtue of the arrangement of reflective components associated with optical path 46, the image of surface portion 70 is inverted with respect to the image of surface 72 as shown in collective image 68 in FIG. 4B. In another embodiment, the addition of a reflective component positioned between reflective components 98 and 102 or between reflective component 102 and article 34 could invert the image of surface portion 70 such that the perspective images of surface portions 70, 72 are oriented the same.

As a result of reflective arrangement 56 (FIG. 5), a single imaging device 16A is positioned in a non-coplanar manner relative to article 34, and more specifically, is positioned in a non-coplanar manner relative to symbol code 35 of article 34. Reflective arrangement 56 has reflective components positioned relative to article 34 to reflect portions of the surface of the article to imaging device 16A. Additionally, use of reflective component 98, which divides or splits optical path 46 into separate path portions as previously discussed, permits image capture of a contiguous periphery of a predetermined region, such as a band of article 34, including an article matrix code or symbol code 35 by imaging device 16A, irrespective the orientation of the article 34. Yet further in addition, reflective arrangement 56, including reflective component 98 provides both split imaging and folded optics (both vertically and horizontally), thereby significantly reducing both the areal footprint and the height of structure 15 (FIG. 3).

As shown collectively in FIGS. 4, 4A, 4C and 6, optical path 48 for imaging device 16B includes a reflective arrangement 58 having reflective components 64, 130, 132, 134, 136, and 138. Optical path 48 of imaging device 16B includes optical path portion 114 extending between imaging device 16B and reflective component 64, optical path portion 116 extending between reflective component 64 and reflective component 130, optical path portion 118 extending between reflective component 130 and reflective component 132, optical path portion 120 extending between reflective component 132 and reflective component 134, and optical path portion 122 extending between reflective path 134 and surface portion 76 of article 34. Surface portion 76, which represents a portion of the image to be captured by imaging device 16B, involves optical path portions 114, 116, 118, 120, and 122 and includes a predetermined portion of the surface of article 34, such as a portion of a band of the surface of article 34 as defined by points B1, B2, D1, and D2 which correspond to an intersection of image plane 140 and article 34 that is coincident with center position 54. Similarly, surface portion 78 is opposite of surface portion 76 and also represents a portion of the image to be captured by imaging device 16B, involves optical path portions 114, 116, 124, 126 and 128 extending respectively, between imaging device 16B and reflective component 64, between reflective component 64 and reflective component 130, between reflective component 130 and reflective component 136, between reflective component 136 and reflective component 138, and between reflective component: 138 and surface portion 78 of article 34. Surface portion 78, which represents a portion of the image to be captured by imaging device 16B involves optical path portions 114, 116, 124, 126 and 128 and includes a predetermined portion of the surface of article 34, such as a band of the surface of article 34 as defined by points B1, B2, D1, and D2 which correspond to an intersection of image plane 140 and article 34 that is coincident with center position 54.

As shown in FIG. 4A, when imaging devices 16A, 16B are used together, each of imaging devices 16A, 16B captures a respective collective image 68, 74 (FIGS. 4B, 4C) of a contiguous periphery of a predetermined region, such as a band of article 34, there is an overlap. Therefore, there is no position along the outer peripheral surface of article 34 in which symbol code 35 would be hidden in at least one image of collective images 68 and 74. For example, even if symbol code 35 were to be positioned in close proximity with any of points A1, A2, B1, B2, C1, C2, D1, or D2, which would represent an edge of the images captured by one of imaging devices 16A or 16B, and possibly not be a “readable image”, that same position of symbol code 35 would be centrally positioned in at least one captured image of the other imaging device 16A or 16B.

As shown in FIGS. 4A, 4C and 6, surface portion 76 and surface portion 78 each represent an image to be captured by imaging device 16B. Since each of opposed surface portions 76, 78 defines the same points (B1, B2, D1, and D2) and the same image plane (140), surface portions 76, 78 represent a contiguous periphery of a predetermined region, such as a band of article 34. A width of the band of article 34 corresponds to a spacing, distance or predetermined region 112, which should correspond to the spacing between indicia 44 associated with structure 15 (FIG. 3). As further shown in FIG. 4C, surface portions 76, 78 are combined in a single collective image 74, in which symbol code 35 is shown as part of the captured image associated with surface portion 76. By virtue of offset 66 (FIG. 4) of reflective components 64, 130 relative to center position 54 (FIG. 4A), in which reflective component 130 is a splitter, i.e., an optical reflective component for dividing or splitting optical path portion or 116 into separate optical path portions were 118, 124, the area of captured image of surface portion 76 is slightly smaller than the area of captured image of surface portion 78 as shown in collective image 74 in FIG. 4C (assuming the same reflective components are used for otherwise symmetric optical path portions 118, 124 and their respective subsequent path portions). Additionally, by virtue of the arrangement of reflective components associated with optical path 48, the image of surface portion 76 is inverted with respect to the image of surface 78 as shown in collective image 74 in FIG. 4C. In another embodiment, the addition of a reflective component positioned between reflective components 130 and 134 or between reflective component in 134 and article 34 could invert the image of surface portion 76 such that the perspective images of surface portions 76, 78 are oriented the same.

As a result of reflective arrangement 58 (FIG. 6), a single imaging device 16B is positioned in a non-coplanar manner relative to article 34, and more specifically, is positioned in a non-coplanar manner relative to symbol code 35 of article 34. Additionally, use of reflective component 130, which divides or splits optical path will 48 into separate path portions as previously discussed, permits image capture of a contiguous periphery of a predetermined region, such as a band of article 34, including an article matrix code or symbol code 35 by imaging device 16B, irrespective the orientation of the article 34. Yet further in addition, reflective arrangement 58, including reflective component 130 provides both split imaging and folded optics (both vertically and horizontally), thereby significantly reducing both the areal footprint and the height of structure 15 (FIG. 3).

As to imaging device 16A, 16B, a camera, scanner or other device capable of capturing a reflected image may be used. For example, an exemplary image capturing device is a DataMan 500, manufactured by Cognex that is headquartered in Natick, Mass. In one embodiment, the image capturing device possesses a small aperture, which increases focal depth, sometimes also referred to as depth of field. Depth of field may be defined as the range of distances in object space for which object points are imaged with acceptable sharpness relative to a fixed position of the image plane (i.e., the plane of the film or electronic sensor). It is desirable for the image capturing device to have a large depth of field, which permits significant variance in the size of articles used with the image capture system, while providing acceptable image clarity without the need to adjust the position of the image capturing device or reflective components of the optical path.

Illumination device must provide sufficient illumination for image capture, in combination with imaging device 16A and/or 16B. In one embodiment, the illumination device may include one or more light emitting diodes (LED), or other acceptable light source.

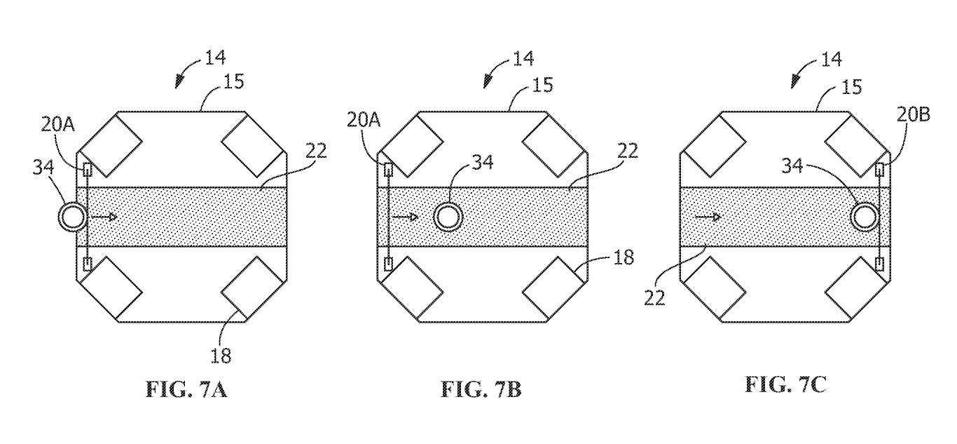

As shown in FIGS. 7A-7C, as article 34 enters structure 15 of image capture system 14 via conveyor 22 in which the articles are serially conveyed relative to reflective arrangements 56, 58 (respective FIGS. 5, 6), the presence of article 34 is sensed by entering detection sensor 20A. In response to article 34 being sensed by entering detection sensor 20A, after a predetermined delay, images of article 34 are captured by imaging devices 16A, 16B (FIG. 4) at a predetermined rate, such as a predetermined time interval or at a predetermined travel interval along conveyor 22, such as shown in FIGS. 4B, 4C. Illumination device(s) 18 (FIG. 6) are illuminated as images of article 34 are captured, in which imaging devices 16A, 16B capture images substantially simultaneously. Image capture may continue for at least one of several circumstances such as until the presence of article 34 is sensed by another sensor, until article 34 travels along conveyor 22 a predetermined travel interval, or until a predetermined number of images of the article have been captured. That is, in one embodiment, image capture devices 16A, 16B may be actuated at predetermined time or travel intervals along conveyor 22 between sensors 20A, 20B. If symbol code 35 of article 34 is not “read” by identification system 10 (FIG. 1), controller 26, which tracks the position of article 34 in the system, actuates reject device 36 to remove article 34 from conveyor 22 and into container 38 as previously described.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An image capture system comprising:
an imaging device; and
a reflective arrangement having reflective components positioned relative to a surface for supporting an article to reflect portions of the surface of the article to the imaging device, the article having a symbol code for identifying the article;
wherein the reflective arrangement reflecting an image of the portions of the surface of the article for capture by the imaging device, the image collectively representing a contiguous periphery of a predetermined region of the surface of the article, the image usable to identify the symbol code on the predetermined region when the article is arranged on the support surface such that the symbol code is positioned between a predetermined range of distances from the support surface, the predetermined range of distances being located within the predetermined region.

2. The system of claim 1, wherein the predetermined region is a band.

3. The system of claim 2, further comprising an adjustment device for adjusting a position of the band of the article image relative to the system.

4. The system of claim 3, wherein the adjustment device adjusts a position of indicia representative of the position of the band.

5. The system of claim 1, further comprising an illumination device operatively associated with the imaging device.

6. The system of claim 5, wherein the illumination device is an LED.

7. The system of claim 1, further comprising a conveyor for serially conveying a plurality of articles relative to the reflective arrangement.

8. The system of claim 1, further comprising a structure for securing the imaging device and the reflective arrangement.

9. The system of claim 8, wherein the structure is substantially enclosed.

10. The system of claim 1, wherein the structure includes indicia representative of a range of the predetermined region.

11. An image capture system comprising:
at least two imaging devices; and
a reflective arrangement having reflective components positioned relative to a surface for supporting an article to reflect portions of the surface of the article to each imaging device, the article having a symbol code for identifying the article;
wherein the reflective arrangement reflecting an image of the portions of the surface of the article for capture by each imaging device, the image collectively representing a contiguous periphery of a predetermined region of the surface of the article, the image usable to identify the symbol code on the predetermined region when the article is arranged on the support surface such that the symbol code is positioned between a predetermined range of distances from the support surface, the predetermined range of distances being located within the predetermined region.

12. The system of claim 11, wherein images are captured by each imaging device substantially simultaneously.

13. The system of claim 11, further comprising an illumination device having at least one LED.

14. The system of claim 11, wherein there is overlap of at least a segment of the periphery of the predetermined region of the surface of the article.

15. The system of claim 11, wherein each reflective arrangement including a splitting device.

16. The system of claim 15, wherein the splitting device for each imaging device is offset from one another.

17. A method for capturing an image comprising:
providing an imaging device;
positioning reflective components relative to a surface for supporting an article to reflect portions of the surface of an article to the imaging device, the article having a symbol code for identifying the article, the reflective components reflecting an image of the portions of the surface of the article for capture by the imaging device, the image collectively representing a contiguous periphery of a predetermined region of the surface of the article, the image usable to identify the symbol code on the predetermined region when the article is arranged on the support surface such that the symbol code is positioned between a predetermined range of distances from the support surface, the predetermined range of distances being located within the predetermined region; and
actuating the imaging device.

18. The method of claim 17, further including positioning an illuminating device relative to the article.

19. The method of claim 17, further including serially conveying a plurality of articles relative to the reflective components.

20. The method of claim 19, wherein actuating the imaging device includes actuating the imaging device at predetermined time or travel intervals while an article is positioned between a first reference point and a second reference point.
